(19) United States
(12) Patent Application Publication
(10) Pub. No.: US 2006/0273890 A1
(43) Pub. Date: Dec. 7, 2006

(54) Tire pressure monitoring system

(76) Inventors: Christos Kontogeorgakis, Plantation, FL (US); Jerry D. Meyerhoff, Buffalo Grove, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/144,466

(22) Filed: Jun. 3, 2005

(51) Int. Cl. B60C 23/00

(52) U.S. Cl. 340/445; 340/447

(57) ABSTRACT

A tire pressure monitoring system (TPMS) (100) includes an inverted F-antenna (102), stem (106) and meandering radiator element (104). The TPMS's operating frequency is controlled by the electrical length of the meandering radiator element (104) without the use of matching circuitry.

### FIELD OF THE INVENTION

This invention relates in general to tire pressure monitoring systems and more specifically to electronic tire pressure monitoring systems.

### BACKGROUND OF THE INVENTION

Tire pressure maintenance is an important safety issue throughout the automotive industry. Both direct and indirect monitoring systems are currently available. Direct tire pressure monitoring systems measure, identify and warn the driver of low tire pressure. Direct systems utilize a small structure including a pressure sensor/transmitter attached to the vehicle's wheel inside the tire's air chamber. An in-car receiver warns the driver promptly if the pressure in any one tire falls below a predetermined level. Indirect tire pressure monitoring systems utilize the vehicle's antilock braking system's wheel speed sensors to compare the rotational speed of one tire vs. the others. If one tire is low on pressure, it will roll at a different number of revolutions per mile than the other three tires, and alert the vehicle's onboard computer.

Because direct systems have a sensor in each wheel, they tend to generate more accurate warnings than the indirect systems and can alert the driver promptly if the pressure in any one tire falls below a predetermined level due to rapid air loss caused by a puncture. Indirect systems have several shortcomings including the lack tof ability to warn the driver which tire is low on pressure and not warning the driver if all four tires are losing pressure at the same rate. Indirect systems are also prone to false warnings. Thus, direct tire pressure monitoring systems are favored.

While direct tire pressure monitoring systems are favored, challenges in manufacturability, reliability and opportunity for improvement still exist. Because of the small structure size of the monitoring system, antenna radiating performance becomes problematic due placement restrictions on the wheel rim and size relative to the wheel well environment. Current systems utilize a shortened monopole antenna created from the tire stem. The use of a shortened monopole antenna requires critical and often lossy matching circuitry to bring the operating frequency within the desired range. Installing the monitoring system also requires an operation that results in stem movement relative to the structure's antenna, making it difficult to electrically connect the structure to the stem and use it in the radiation system.

Accordingly, there is a need for an improved tire pressure monitoring system.

### BRIEF DESCRIPTION OF THE DRAWINGS

The present invention is illustrated by way of example and not limitation in the accompanying figures, in which like references indicate similar elements, and in which:

FIG. 1 is an illustration of a tire pressure monitoring system formed in accordance with the present invention;

FIG. 2 a top view of FIG. 1 in accordance with the present invention;

FIG. 3 is an example of a simulation of return loss for a tire pressure monitoring system in accordance with the present invention; and

FIG. 4 illustrates a tire pressure monitoring system formed in accordance with the present invention coupled to a wheel well.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

The instant disclosure is provided to further explain, in an enabling manner, the best modes of making and using various embodiments, in accordance with the present invention. The disclosure intends to enhance the perception and appreciation of the inventive principles and advantages thereof, rather than to limit in any manner the invention. The invention is defined solely by the appended claims, including any amendments made during the pendency of this application, and all the equivalents of the claims, as issued.

It is further understood that the relational terms, if any, such as first and second, top and bottom, and the like, are used solely to distinguish one entity or action from another, without necessarily requiring or implying any actual relationship or order between such entities or actions.

Briefly, in accordance with the present invention, there is provided herein a tire pressure monitoring system (TPMS) that utilizes an inverted F antenna in conjunction with a meandering portion coupled to a stem. The TPMS formed in accordance with the present invention does not require any matching circuitry as the electrical length of the meandering portion provides the desired resonant frequency.

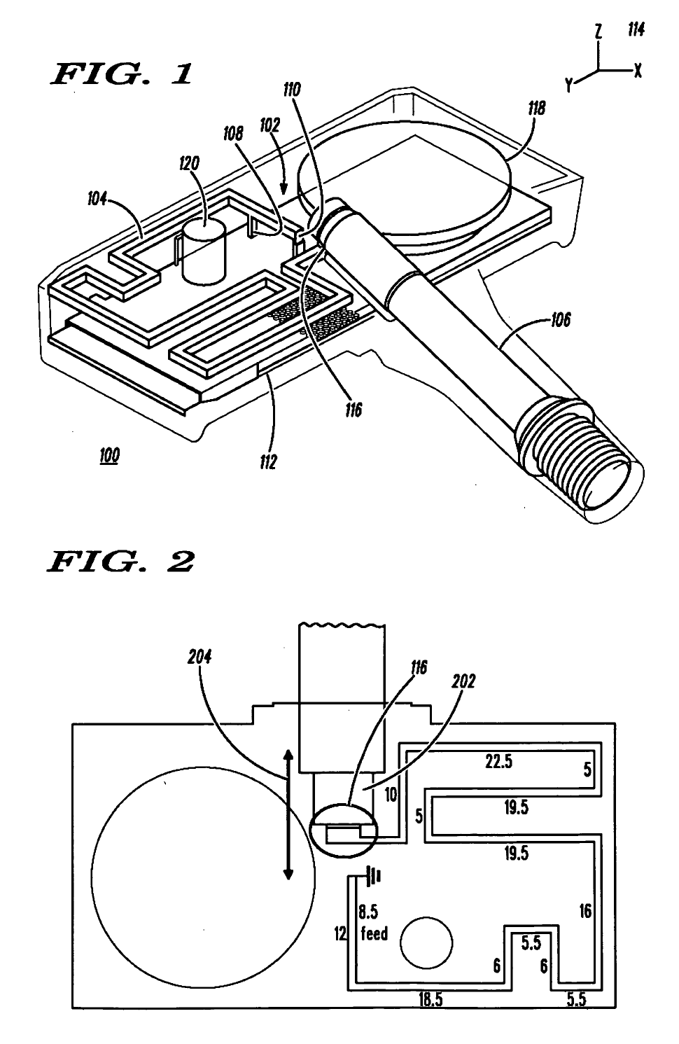

FIG. 1 is an illustration of a tire pressure monitoring system (TPMS) formed in accordance with the present invention. In accordance with the present invention, TPMS 100 includes an inverted F antenna 102, meandering radiating element 104 and stem 106. The inverted F antenna 102 provides a feed connection 108 and ground connection 110 with printed circuit board 112. Viewed as a three dimensional structure oriented in x-y-z planes 114, the meandering radiating element 104 is formed in the x-y plane, while the feed and ground connections are formed along the z-axis. The meandering radiating element 104 is coupled to the stem 106 via flexible conductive means 116, such as wire, metal strip or other conductive material. A battery 118 powers transmitter/sensor circuitry 120. Transmitter/sensor circuitry 120 feeds tire pressure information signals via feed 108 through the meandering radiator element and transmits the signals out using the stem 106. A remote receiver (not shown) located in the vehicle, receives the signals and alerts the driver to low tire pressure levels.

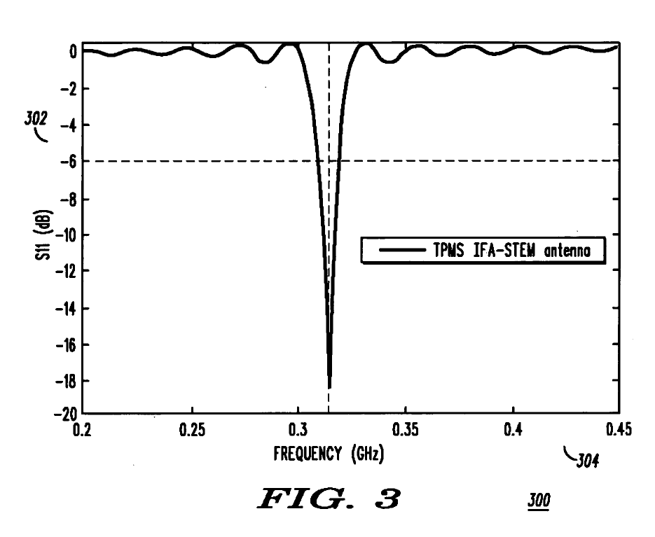

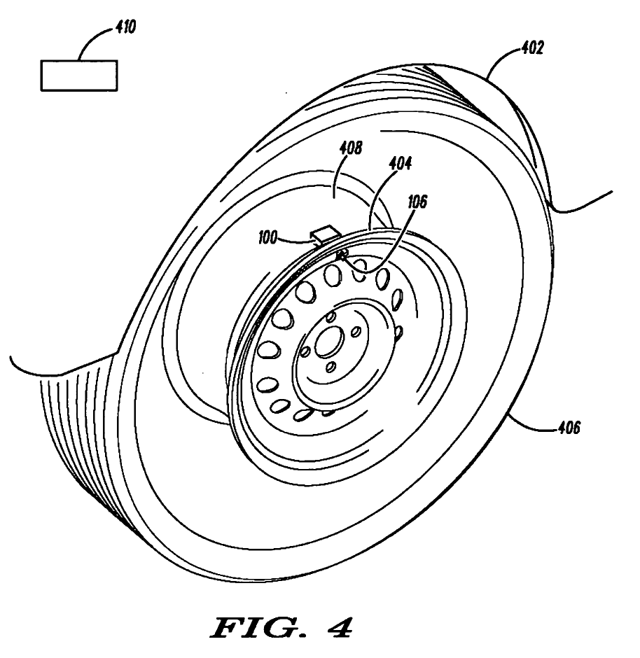

In accordance with the present invetion, TPMS 100 has an operating frequency tuned by the meandering radiator element's eletrical length, without the use of any matching circuitry. The meandering radiator element 104 is preferably formed using a thin metal, for example copper or aluminum, and for most applications, a minimum spacing of 2 mm is advisable. FIG. 2 a top view the TPMS of FIG. 1. In this view, examples of dimensions (in mm) used for the meandering radiating element 104 are shown. For this example, the physical length of the wire connecting the antenna feed 108 to the stem valve 202 was 158 mm and immersed TPMS plastics. The distance between the feed and the ground connections was 8.5 mm. FIG. 3 is graph 300 showing simulated results of return loss 302 versus frequency 304 for a TPMS formed with the dimensions of in FIG. 2. The return loss shows a self-resonant frequency of approximately 315 MHz with a 10 MHz bandwidth. If the TPMS 100 were to be used at 433 MHz, then the length of the meandering portion can be shorted appropriately. The length of the meandering radiating element 104 can be adjusted (lengthened/shortened as desired) to achieve the desired frequency for a given application. Frequency bands of: 315 MHz, 433 MHz and 868 MHz with sufficient bandwidth can all be achieved. The TPMS formed in accordance with the present invention is thus easy to tune as it does not require the use of a matching network.

Good electrical contact can be achieved by soldering the last segment of the radiator element 104 to the valve 202, such that the meandering portion flexes as a spring. During mounting of the stem 106 to a wheel well, the stem is pushed out relative to rest of the structure. By having the meandering radiator element 104 in the x-y plane, the last meandering segment flexes as a spring which moves along with the stem as shown by motion designator 204 in FIG. 2. The flexibility with which the connection is made between the meandering radiator element 104 and the stem 106 maintains the electrical connection without breakage or intermittencies.

FIG. 4 illustrates the tire pressure monitoring system 100 in a vehicle 402 in accordance with the present invention. TPMS 100 is coupled to a wheel well 404 inside a tire's 406 air chamber 408. The TPMS 100 is mounted to the interior of wheel well 404 via stem 106. Stem 106 is shown pushed out relative to rest of the structure as mentioned previously. TPMS 100 is used to provide direct tire pressure monitoring by measuring, identifing and warning a driver of the vehicle 402 of low tire pressure. An in-car receiver 410 warns the driver if the pressure in any one tire falls below a predetermined level.

Eliminating the use of a monopole antenna allows the TPMS structure of the present invention to be formed without the use of matching circuitry. The compactness and flexibility achieved by using a meandering radiator element provides a good electrical connection to be maintained as the tire rotates. Breakage associated with previous monopole antennas is no longer an issue.

This disclosure is intended to explain how to fashion and use various embodiments in accordance with the invention rather than to limit the true, intended, and fair scope and spirit thereof. The foregoing description is not intended to be exhaustive or to limit the invention to the precise forms disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A tire pressure monitoring system (TPMS), including:
an inverted F antenna;
a meandering radiating element coupled to the inverted F antenna; and
a stem coupled to the meandering radiating element.

2. The TPMS of claim 1, wherein the TPMS's operating frequency is tuned by the electrical length of the meandering radiator element.

3. The TPMS of claim 2, wherein the operating frequency is controlled by the electrical length of the meandering radiator element without the use of matching circuitry.

4. The TPMS of claim 1, wherein the inverted F antenna provides a ground connection and a feed connection via coupling to a circuit board.

5. The TPMS of claim 4, wherein the ground and feed connections are orientated along a z-axis and the meandering radiator element is oriented in an x-y plane of an x-y-z orientation.

6. The TPMS of claim 1, wherein the meandering radiator element comprises a conductive wire.

7. The TPMS of claim 1, wherein the stem includes a stem valve and the meandering radiator element is flexibly coupled to the stem valve.

8. The TPMS of claim 1, wherein the TPMS is mounted via the stem to a wheel well inside a tire's air chamber.

9. The TPMS of claim 1, wherein the TPMS provides direct tire pressure monitoring.

10. The TMPS of claim 4, further including:
an air pressure sensor for sensing tire pressure information; and
a transmitter for transmitting the tire pressure information through the feed to the meandering radiator element.

11. A vehicle, including:
a receiver:
a tire having a wheel well; and
a tire pressure monitoring system (TPMS) mounted to the interior of the wheel well, the TMPS transmitting tire pressure information via an inverted F antenna coupled to a meandering radiator element feeding into a stem.

12. The vehicle of claim 11, wherein the TMPS has an operating frequency tuned by the meandering radiator element's electrical length without matching circuitry.

13. The vehicle of claim 11, the meandering radiator element is flexibly coupled to the stem.
